(19) United States
(12) Patent Application Publication
(10) Pub. No.: US 2009/0060674 A1
(43) Pub. Date: Mar. 5, 2009

(54) Washer-lock washer and methods for making and using the same

(76) Inventor: Mark L. Kluga, Libertyville, IL (US)

Correspondence Address: MARK L. KLUGA, 15605 IDLEWOOD LN., LIBERTYVILLE, IL, 60048, US

(21) Appl. No.: 12/228,498

(22) Filed: Aug. 13, 2008

Related U.S. Application Data
(60) Provisional application No. 60/935,420, filed on Aug. 13, 2007.
(60) Provisional application No. 61/069,717, filed on Mar. 17, 2008.

(51) Int. Cl. F16B 39/24; B21D 53/20

(52) U.S. Cl. 411/149; 470/42

(57) ABSTRACT

A washer-lock washer is disclosed that can be used with a fastener. In one form the washer-lock washer is integrally connected. In another form the washer-lock washer is joined together from two separate pieces. The washer-lock washer may be provided with additional locking features, which would include nubs, indentations, protrusions or cones. This latter concept of the present invention can also be incorporated into a separate lock washer. In another form, the lock washer portion is a separate piece with additional locking features. In another form the washer-lock washer is combined with a fastener. In another form, the washer portion of the washer-lock washer can be welded in place to the mating part or secured by some other means. The washer-lock washer and washer lock-washer fastener combination expedites assembly of products using the same, and can be used to hold together parts in conjunction with either a threads in one of the parts or a separate nut. Various forms for the locking portion are also disclosed.

This application is a continuation-in-part United States Non-Provisional application claiming priority of and benefit of the filing dates of U.S. Provisional Patent applications Ser. No. 60/935,420, of Aug. 13, 2007 and Ser. No. 61/069,717 of Mar. 17, 2008 by the present inventor Mark L. Kluga and relates to a washer-lock washer unit and methods for making and using the same.

### BACKGROUND OF THE INVENTION

Heretofore, it has been known to make a plain washer, generally a circular or non-circular disk with a hole or opening in the center, generally to receive a bolt or fastener. It was also known to make a split lock washer, generally a circular or near circular arcuate piece with a hole or opening in the center for the same purpose and a split or slit therein with the adjacent ends offset. These two separate pieces (washer and lock washer) are generally separately formed as by punching or winding around a mandrel from a strip or coil or wire of material, such as steel, and after formed may be heat treated. In use generally the lock washer may be placed on a bolt, or fastener, and then in a separate step, the washer is put on the bolt. The bolt with the lock washer and separate washer thereon are placed into a part to be secured and then threaded into an opening in another part or a nut and tightened to the required tightness. With the prior art washer and lock washer, two separate operations were needed both to form and also just to place the two separate washers on the bolt or fastener.

### SUMMARY OF THE INVENTION

The present invention is the creation of a unitary washer-lock washer which can be formed from a coil or strip, in this instance the same strip, of material, such as, for example, steel or non-ferrous material. In the present invention, the washer portion and lock washer portion are formed and integral with or joined to each other. In making, the washer-lock washer may be formed generally at the same time, say as by punching in die on a punch press, and then the washer-lock washer portions are folded over in a die so that the fastener holes in both portions are generally axially aligned. The washer-lock washer structure could be formed by operations in a progressive die or 4-slide die or from a mold or other types of tooling, with for example, the two holes being formed, then the portions' outlines being punched, the slit in the lock washer formed, and in one or more operations, the portions relatively folded over approximately 180° so that the two openings generally axially align. Of course other orders of operation could be used. The portions can then be heat treated and plated as desired. The washer portion can be of any suitable configuration, the normal round, or square (see FIGS. 16A & 16B), triangular, rectangular, or other geometric or curved shape, as desired or required. The washer-lock washer may also be formed of initially two separate pieces, formed say at separate times and then joined together by various means, such as stacking, welding, coining, hanging, etc.

In use in assembling say a manufactured product, the time and operations to place the prior art washer and lock washer on a fastener is essentially cut in half, as the washer-lock washer of the present invention is simultaneously placed on or under the fastener in a single operation, and then the fastener with both washers in place installed into the part to be secured and into the threaded opening or nut and tightened as required. Of course, this procedure could be altered to accommodate the washers located adjacent or under a nut, rather than adjacent the head of or on the fastener. Considerable assembly time and effort can be saved by use of the combined, integral washer-lock washer of the present invention. This construction is a value added product for the end user (be it manufacturer, assembler, end user or re-builder). For example, the time lost when one of the washer or lock washer of the conventional, two separate piece construction, is dropped and has to be picked up or recovered or another put in its place, is eliminated or avoided. Further, customer dissatisfaction which results when the customer discovers its newly purchased machine does not have all the needed washers or lock washers at each location is eliminated or avoided, and any customer questioning of the quality of the remainder of the machine or its assembly avoided.

Further, the washer-lock washer can be combined with an appropriate size fastener and further assembly time saved by the use of such ready to install in one operation fastener, washer-lock washer combination.

Objects of the Present Invention

It is an object of the present invention to develop a combined washer-lock washer.

Another object is to provide a washer-lock washer which can be placed on a fastener together.

Yet another object is to develop a washer-lock washer which expedites assembly and reduces the time and effort to place both washers on a fastener.

Still another object is to provide a washer-lock washer which can be used on a fastener to secure parts together with a threaded opening in one of the parts or a separate threaded nut.

Yet another object is for the washer portion of the washer-lock washer to be welded to the mating part or secured by some other means.

Yet another object is to provide a method for manufacturing the washer-lock washer of the present invention.

Still a further object is to provide a method for forming the washer-lock washer of the present invention.

Another object is to provide means for using the washer-lock washer of the present invention to more quickly assemble parts together.

Still a further object is to provide a die or tool for forming the washer-lock washer of the present invention.

Still a further object of the present is to provide a washer-lock washer, fastener combination, ready for use and/or to be threaded into a threaded opening in a part or nut.

Yet a further object is to provide the washer-lock washer fastener (be it bolt or nut) combination ready for use, wherein the washers are held in place on the fastener.

Still a further object is to provide serrations or locking features on the mating surface of the washer-washer lock and/or associated mating surface of the fastener so as to provide further enhanced locking features between the fastener (bolt or nut) and washer-lock washer.

Yet a further object is to provide serrations or locking features on the mating surface of the washer-lock washer so as to provide further enhanced locking features between the fastened part and washer-lock washer.

Still a further object is to provide the lock washer portion as a separate item with additional locking features, such as protrusions or cones, not currently provided on prior art lock washers due to their method of manufacture.

These and other objects of the present invention will become apparent from the following written description and accompanying figures of drawings wherein:

### BRIEF DESCRIPTION OF THE DRAWINGS

FIGS. 1A and 1B are perspective views of a washer-lock washer of the present invention taken from different view points.

FIGS. 1C, 1D, 1E, 1F and 1G are drawings from my first provisional application of a lock washer like that shown in FIGS. 1A and 1B.

FIG. 2A is a schematic plan view of the strips of stock from which the washer-lock washer of the present invention can be progressively made.

FIG. 2B is a side elevational view of the strip of stock shown in the last operation of FIG. 2A prior to folding.

FIG. 3A is a schematic of plan views showing how the washer-lock washer of the present invention can be folded from the strip of stock shown at the right in FIGS. 2A and 2B.

FIG. 3B is a schematic of corresponding elevational views to FIG. 3A showing how the lock washer and washer portions can be relatively folded over to form the washer-lock washer of the present invention.

FIG. 4A is a schematic plan view of the die or one form of tool for forming the washer-lock washer of the present invention.

FIG. 4B is a schematic elevational view of the die for forming the washer-lock washer of the present invention.

FIG. 5A is a first schematic arrangement of a series placement of a line of washer-lock washers of the present invention.

FIG. 5B is a second schematic arrangement of a more efficient placement of a line of washers angled off depending on the diameters of the washer and lock portions resulting in less waste.

FIGS. 6A and 6B are schematic views, similar to FIG. 5A and 5B, but showing how a “gang” of washer-lock washers of the present invention can be formed.

FIG. 7A is an exploded schematic view showing how one part can be secured to a second part having a threaded opening to receive a fastener with a washer-lock washer of the present invention.

FIG. 7B is a cross-sectional assembled view of the parts shown in FIG. 7A.

FIG. 8A is an exploded schematic view showing how one part can be secured to a second part with a fastener with a washer-lock washer of the present invention and a threaded nut.

FIG. 8B is a cross-sectional assembled view of the parts shown in FIG. 8A.

FIG. 9 is a schematic view showing a fastener, washer-lock washer combination of the present invention ready for use with a threaded opening or nut.

FIGS. 10A, B and C are schematic views showing how the mating surfaces (FIG. 10A, and/or FIG. 10C) of the lock nut portion of the present invention prior to folding can have serrations which would cooperate with associated serrations on a conventional serrated nut or bolt head and/or fastened part to increase the “hold.”

FIGS. 11A and 11B are schematic views of other embodiments of the washer-lock washer of the present invention, wherein one or more of washer-lock washer portions are of the star or serrated type in prefold and folded forms.

FIGS. 12A and 12B are schematic views of other embodiments of the washer-lock washer of the present invention, wherein one or more of washer-lock washer portions are of the star type in prefold and folded forms.

FIGS. 13A and 13B are schematic views of still other embodiments of the washer-lock washer of the present invention, wherein one or more of washer-lock washer portions are of the star type in a prefold and folded forms.

FIGS. 14A and 14B are schematic views of yet other embodiments of the lock washer-lock washer of the present invention, wherein one or more of washer-lock washer portions are of the star type in prefold and folded forms.

FIGS. 15A and 15B illustrate two components, a nut and washer-lock washer prior to assembly to form a fastener in the form of a nut, washer-lock washer combination shown in the latter figure.

FIGS. 16A and 16B show a non-round washer portion joined integral with a round lock washer portion forming a square washer-lock washer of the present invention with the lock washer having “hold” enhancing protrusions (FIG. 16A) and the washer having cone-shaped dimples for a similar purpose.

FIGS. 17A and 17B show a washer-loc washer similar to FIGS. 16A and 16B, but with a round washer portion, and the protrusions and cones or dimples for enhanced grip.

FIGS. 18A and 18B show a separate lock washer, which could be used separately, or could be joined to a washer portion, that has the enhance grip protrusions on one or both sides.

FIG. 19 illustrates the method and die or tool used for making the washer shown in FIGS. 18A and 18B.

### DESCRIPTION OF THE PREFERRED EMBODIMENTS

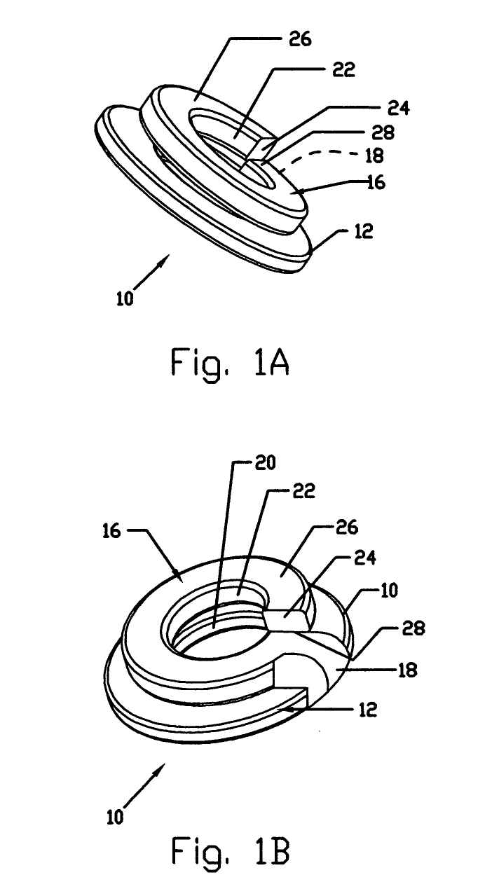

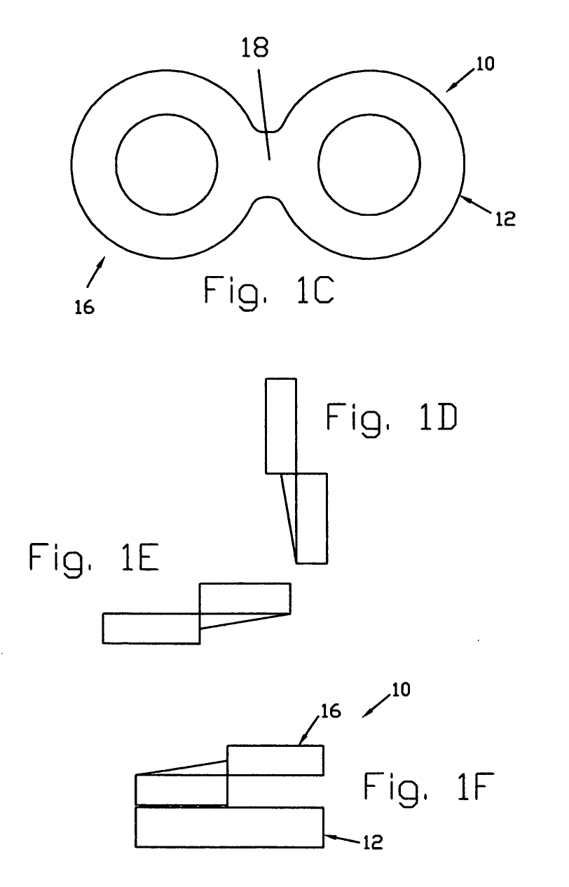

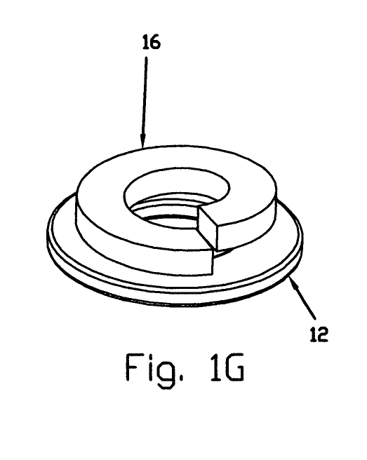

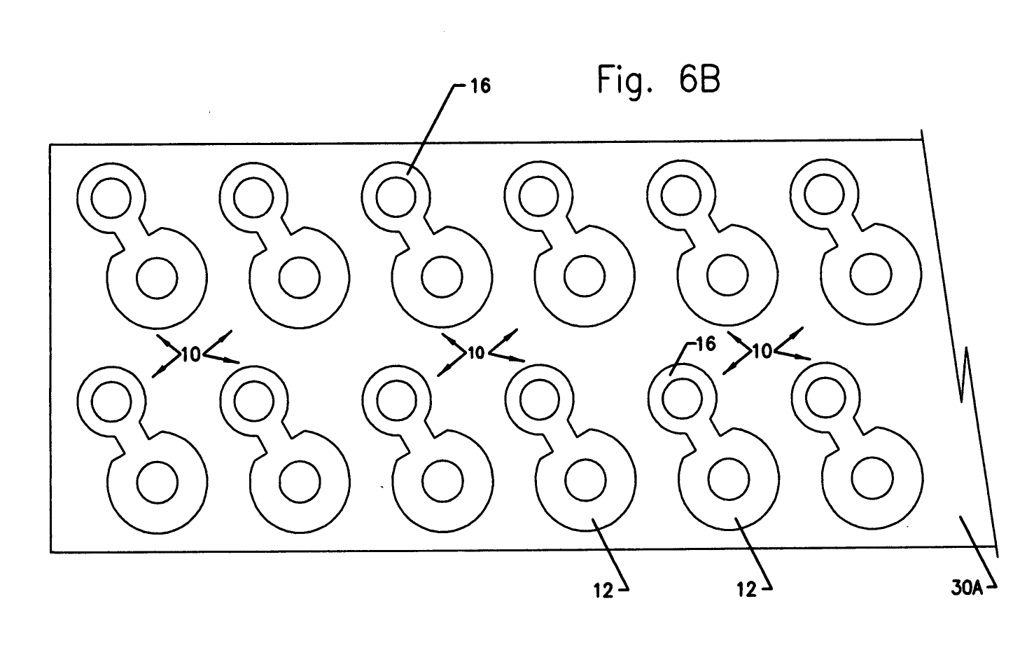

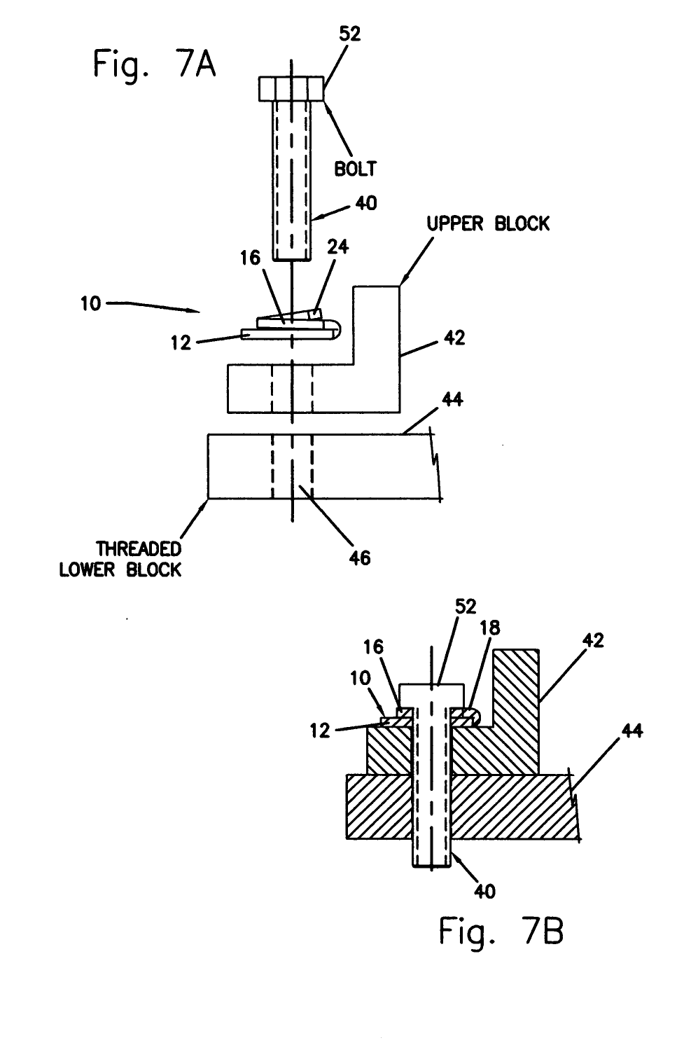

Referring to FIGS. 1A, 1B, 1C, 1D, 1E, 1F and 1G the washer-lock washer 10 of the present invention comprises a washer portion 12 and a lock washer portion 16, formed and joined together or made integral by the adjacent connecting tab 18 connected to both portions 12 and 16. Each portion 12 and 16 has an appropriate sized (diameter) opening 20 and 22, respectively, to receive a fastener or bolt, which may be of a conventional type, with which it is to be used. See FIGS. 7A to 9 and 15B. The lock washer portion 16 may be of the split or other type, and, in this instance, has a split 24, with its respective ends 26 and 28 relatively axially offset from one another. Note the connected end 28 is closely adjacent the tab 18 to maximize the length of the offset portion and its free end 24.

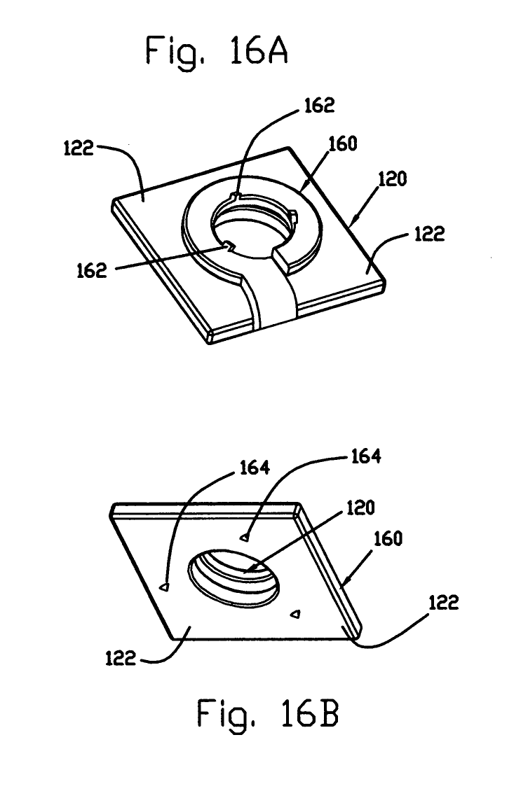

As noted in FIGS. 16A and 16B the washer portion of the washer-lock washer of the present invention is not restricted to the normal round profile, but could have a non-round profile, such as rectangular, square (as shown), triangular or other curved (but flat or planer) shape. Likewise the interior opening could also be of a non-round shape, such as like any mentioned above, and for example, square to receive a square portion of a carriage bolt.

It should be understood that such non-round washer portion lock washers could be manufactured and used in a manner similar to that described below for the washer-lock washer 10 of the present invention with the round style washer portion 12.

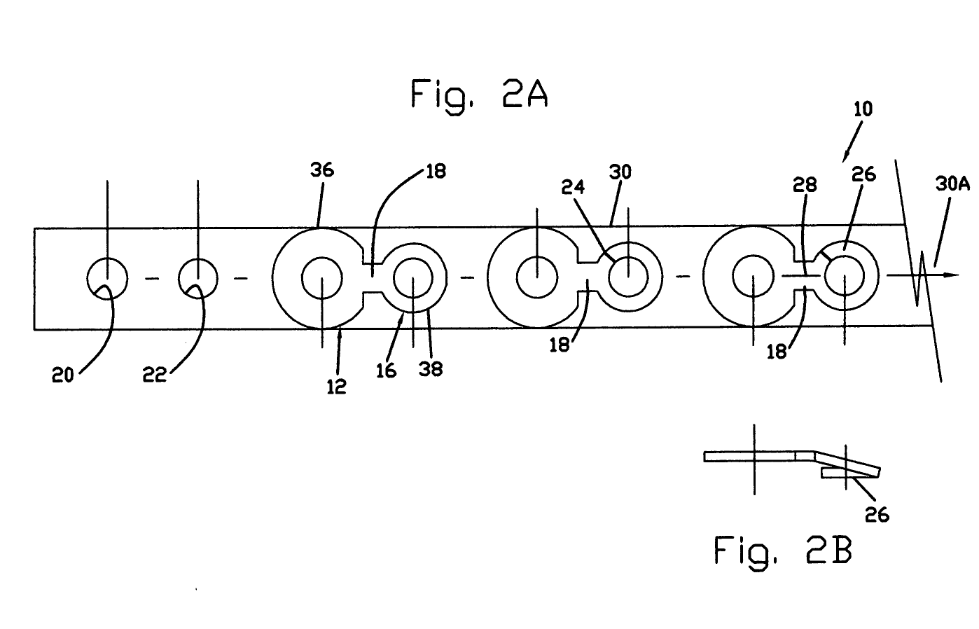

Referring to FIG. 2A and 2B, the washer-lock washer 10 of the present invention, includes the others just described, and in one manner, can be formed from a strip 30 of stock material, e.g., steel, alloy, steel, stainless, bronze, plastic. Of course, other materials could be used. Moving from left to right as indicated by the arrow 30A, the openings 20 and 22 are punched or formed; then the profiles 36 and 38 of portions 12 and 16 as formed; then the split 24 formed and the end 26 offset. Now the above and/or following order of operations could be altered and still fall within the present invention. These operations could be progressive for an individual blank, and or carried on simultaneously for several flanks.

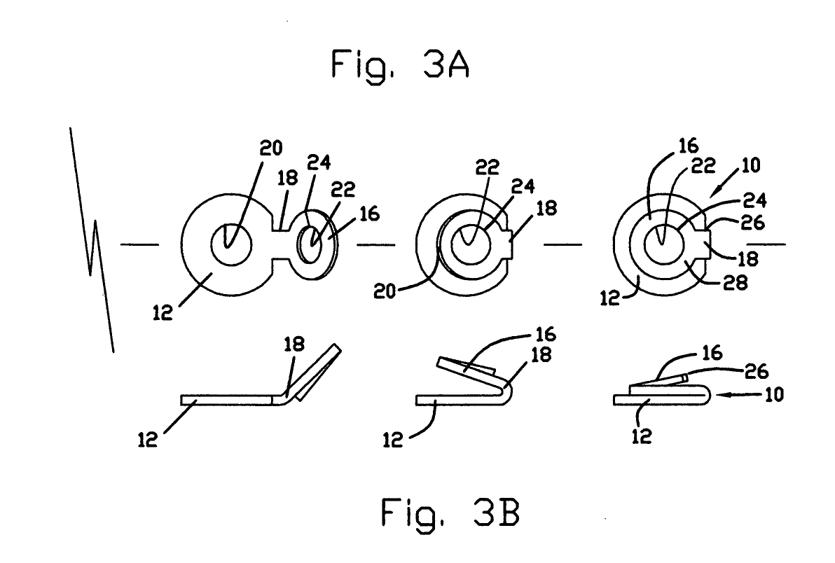

Referring to FIG. 3A (plan view) and 3B (elevation), the part from FIGS. 2A and 2B can then be folded over in steps approximately 180° so that the openings 20 and 22 generally axially align.

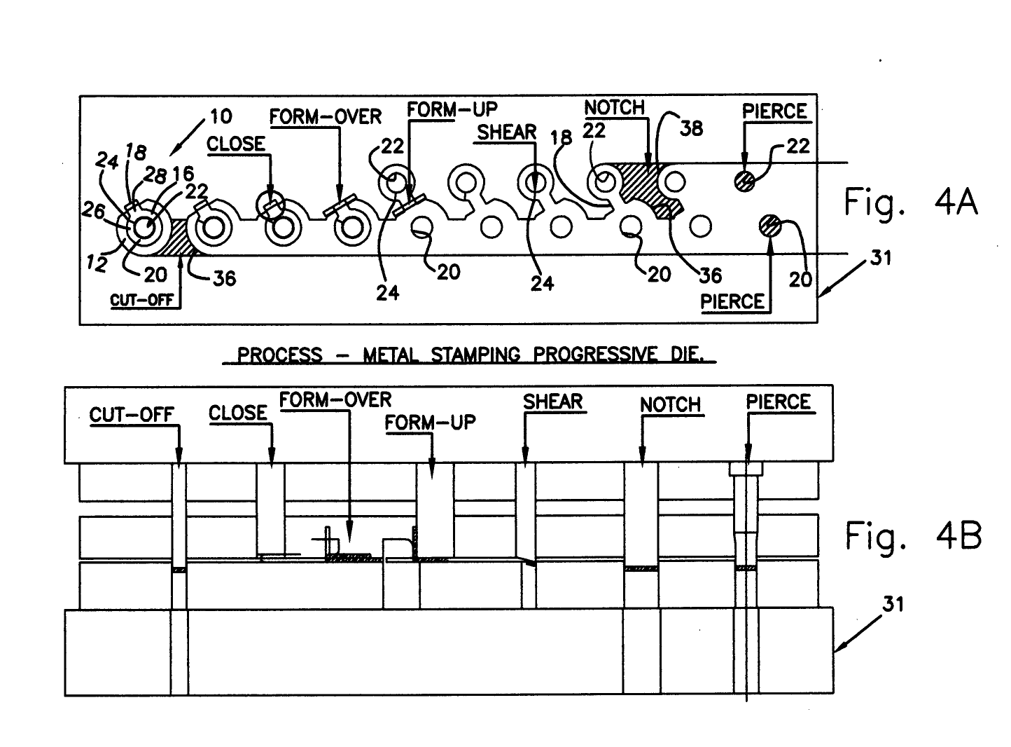

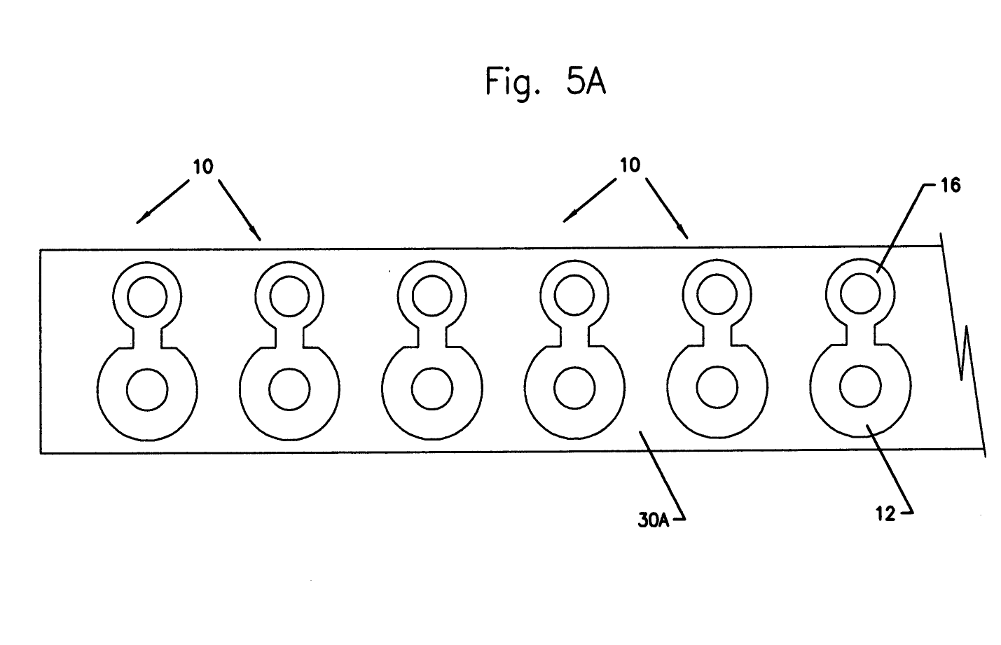

Now referring to FIG. 4A and 4B, the washer-lock washer 10 of the present invention can be formed, for example, by progressively forming on a die 31 as by punching, the holes 20 and 22, then portions of the outlines 36 and 38 of the respective washer portions 12 and 16, including the connecting tab 18, forming the slit 24 forming up, over and closing the portions 12 and 16 (folding them relatively over), and forming the remainder of the portions 36 and/or 38 to cut off or free one washer-lock washer 10. The strip is then moved or indexed to the left here relative the die 31 to complete the next washer-lock washer. For example, the die 31, like that shown in FIG. 4A and 4B, can be used to progressively form the washer-lock washer of the present invention, carrying out the steps illustrated in FIGS. 2A, 2B, 3A and 3B and listed in FIGS. 4A and 4B. The washer-lock washer 10 of the present invention could also be formed by other means, such as 4-slide die. The washer-lock washer 10 could also be formed of any material which a conventional washer is made such as steel, various alloys, stainless steel, bronze, brass, monel, copper, etc.

The washer-lock washer of the present invention could be formed of plastic, or say nylon, as by injection molding. Other high strength materials or plastics could be used such as pvc, polyesters, etc.

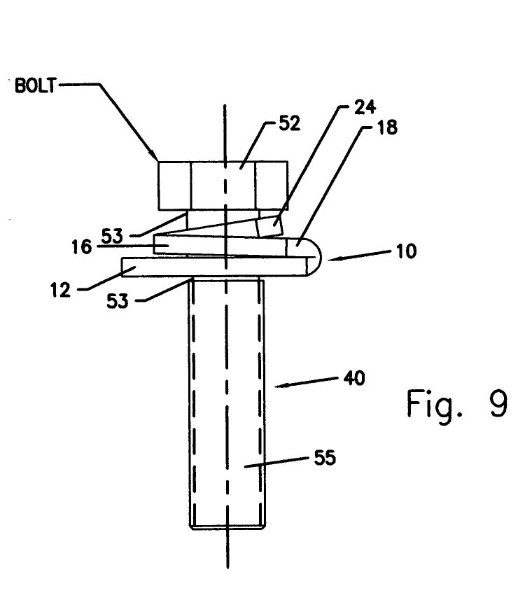

Further, the washer-lock washer of the present invention could also have a plurality serrations 39 (or alternatively raised or hollow elements) on either side or both sides of the lock washer or washer portions to accommodate complementary serrations formed on the mating surface(s) of the associated fastener (bolt or nut) or adjacent surface of one of the parts being secured. See FIG. 10 for an example of this construction, before the folding operation.

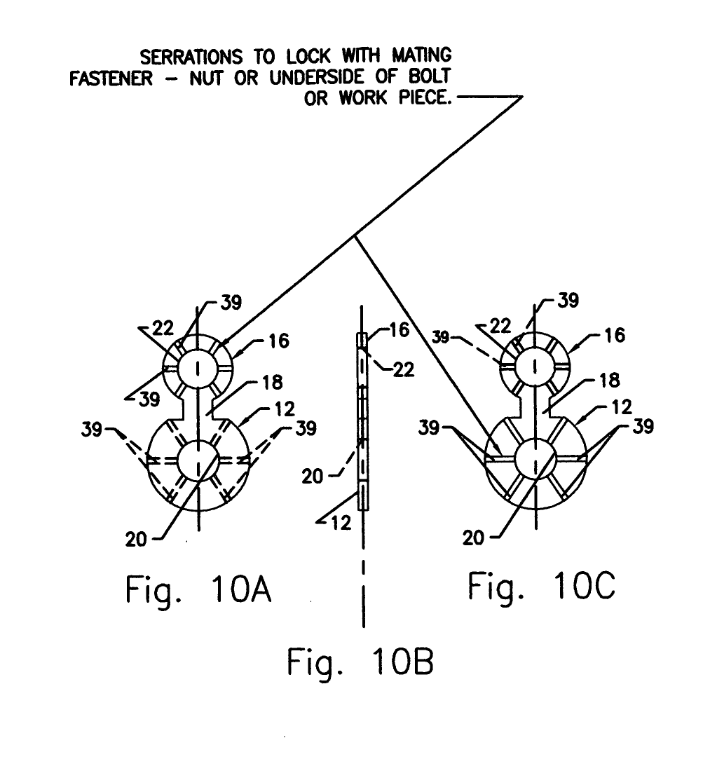

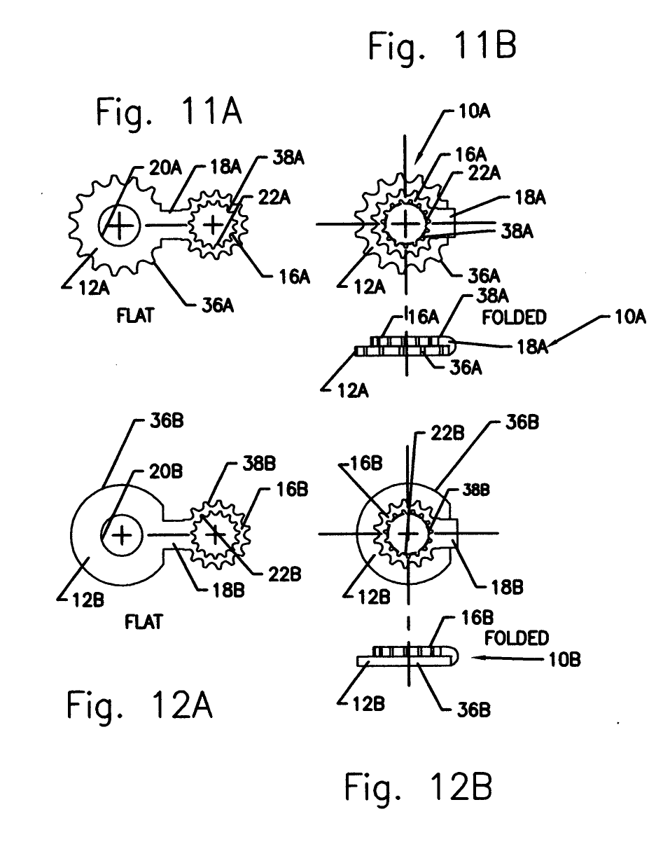

Other type lock washer construction portions could be utilized as the lock washer portion of the lock washer-lock washer of the present invention, such as internal and external type star washers. See FIG. 11A and 11B to 14A and 14B for various combinations of washer-lock washers having one or more internal and/or external star provisions, some with round profiles.

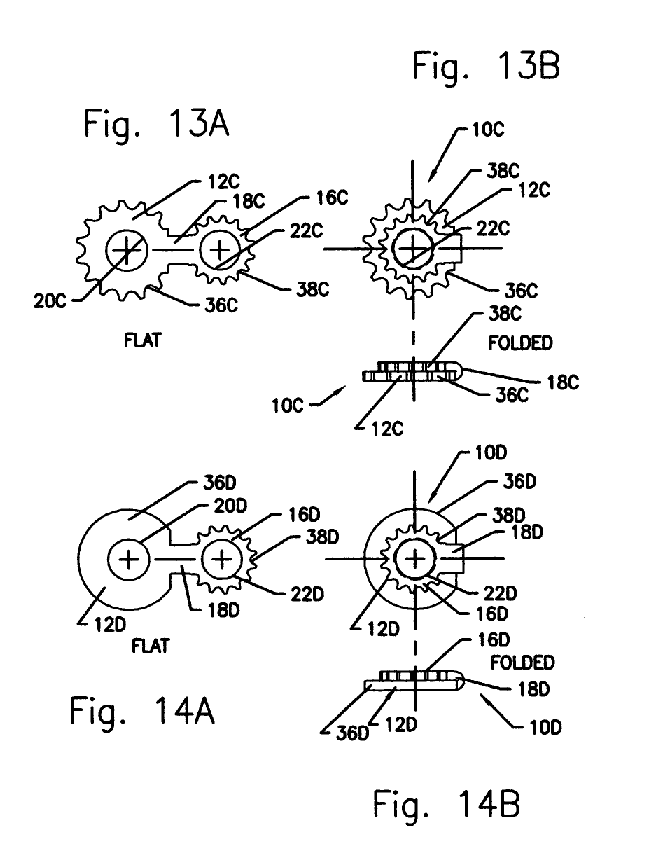

In FIG. 11A (flat) and FIG. 11B (folded), the washer portion 12A has a round (but may have a semi-round) internal hole 20A and an external star 36A, while the smaller lock portion 16A has both internal 22A and external star 38A configuration, with the portions 12A and 16A joined by the tab 18A. In FIG. 12A (flat) and FIG. 12B (folded), the washer portion 12B has a round (or semi-round) internal hole 20B and an external smooth profile 36B, while the smaller lock portion 16B has both internal 22B and external star 38B configuration, with the portions 12B and 16B joined by the tab 18B. In FIG. 13A (flat) and FIG. 13B (folded), the washer portion 12C has a round (or semi-round) internal hole 20C and an external star 36C, while the smaller lock portion 16C has a round (or semi-round) internal hole 22C and external star 38C configuration, with the portions 12C and 16C joined by the tab 18C. In FIG. 14A (flat) and FIG. 14B (folded) the washer portion 12D has a round (or semi-round) internal hole 20D and a smooth external edge 36D, while the smaller lock portion 16D has a round (or semi-round) internal hole 22D and an external star 38D configuration, with the portions 12D and 16D joined by the tab 18D. It should be understood that other combinations of smooth internal/external edge and star internal/external edges could be used and such would fall within the scope of the present invention. It should be further understood that the washer portion, could also have a non-round profile, such as square, rectangular, triangular, etc. as desired.

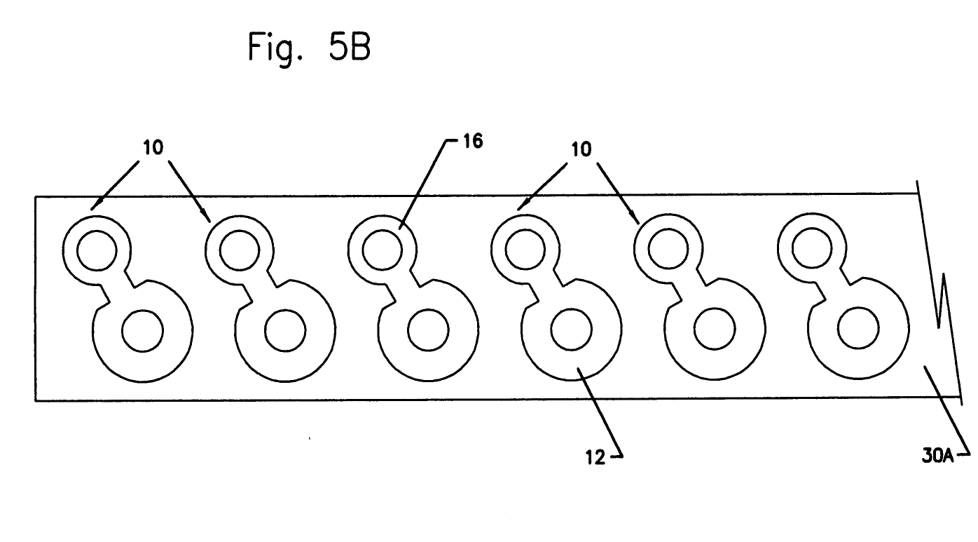

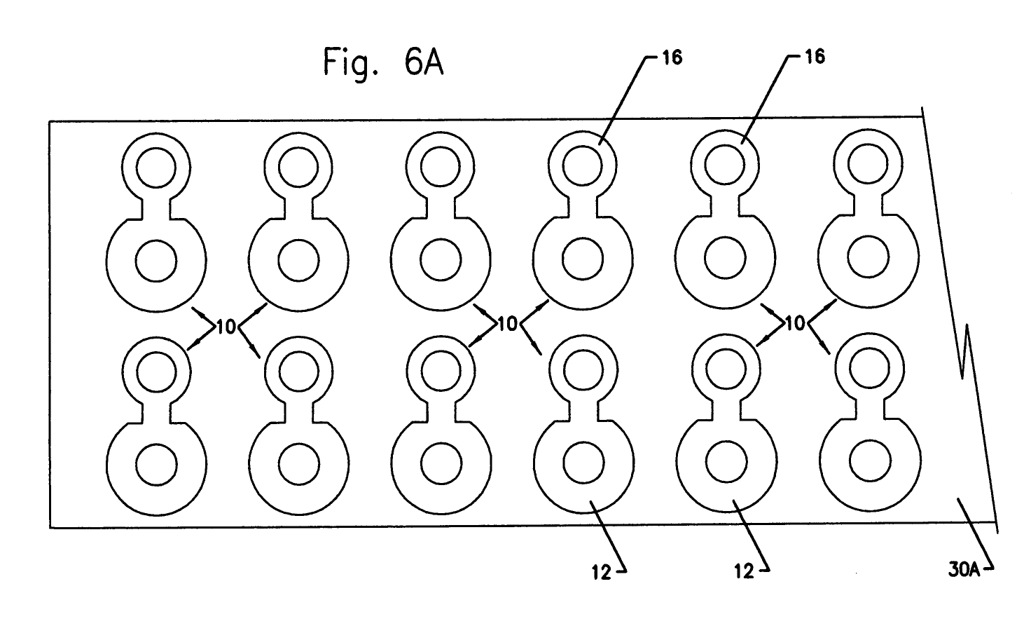

While only a single washer-lock washer 10 is being formed on the strip 30 as shown in FIGS. 5A and 5B, they could be “gang” formed several at a time on a wider strip 30A, as shown in FIG. 6A and 6B. Of course, even more rows than two could be provided on even a wider strip. It should be noted that by angularly aligning the washer in accord with the external diameters of the portions 12 and 16, results in a more compact arrangement and less waste, similarly to the savings of FIGS. 5B over 5A or FIG. 6B over FIG. 6A arrangements. Of course the strips 30 in FIGS. 6A and 6B would utilize a “grouped” or multiple die having multiple provision of the die shown in FIGS. 4A and 4B.

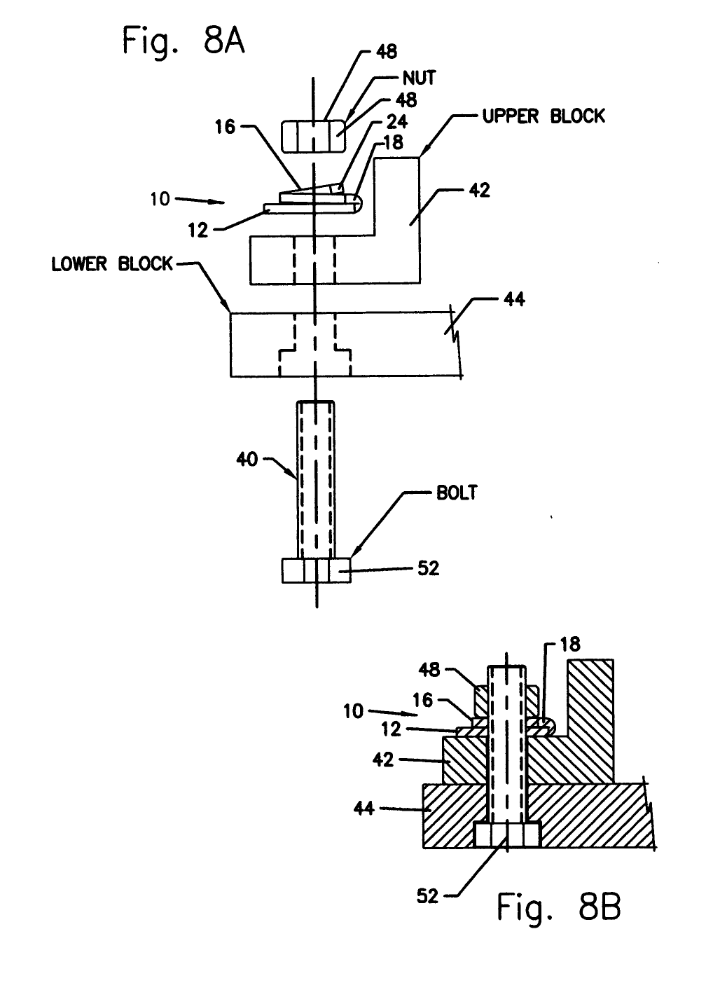

FIGS. 7A and 7B and 8A and 8B illustrate how the washer-lock washer 10 of the present invention can be placed on a fastener 40 and used to secure parts 42 and 44 together, as by screwing the fastener 40 into a threaded opening 46 (FIG. 7B) and/or with a threaded nut 48 (FIG. 8B). It should be understood that the washer-lock washer 10 of the present invention, when a nut 48 is utilized, could be either adjacent the head 52 of the fastener 40 and/or the nut 48.

In the present invention, assembly is speeded as the steps of placing both a conventional washer and a conventional lock washer on or under a fastener is reduced and cut in half or more as both a washer-lock washer are placed with a single operation. Also in the present invention, damage to the work piece 42 (FIG. 7A) caused by use of the lock washer alone is eliminated.

Further time can be saved by providing the assembler with an appropriate sized fastener or bolt (selected diameter, length and thread size) with the washer-lock washer already assembled thereon. Slight misalignment of the washer portion 12 and lock washer portions 16 and their openings 20 and 22, say during or after forming, could be used to hold the washer-lock washer 10 into the fastener 40, adjacent the head 52, with a very slight interference fit, until utilized during assembly. Alternatively the fastener could have a slightly recessed portion 53 between the threads 55 and head 52 to permit the washer-lock washer to freely rotate, but yet be retained on the fastener. See FIG. 9.

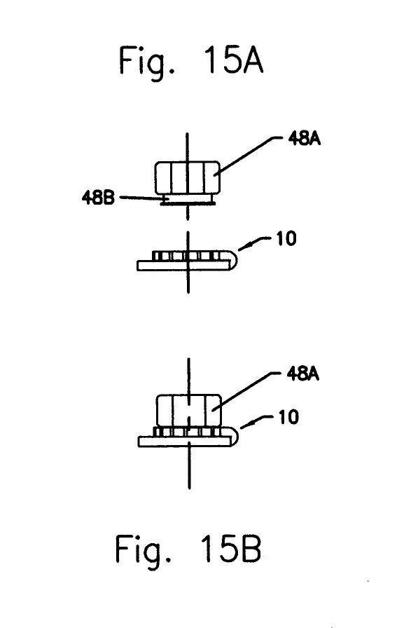

Likewise a washer-lock washer 10 of the present invention could be attached to a nut 48A, as by inserting the same onto a nut extension 48B and then peaning or coining over the extension 48B to permit the washer to relatively rotate but yet be held or captured onto the nut. See FIGS. 15A and 15B.

In alternative the washer-lock washer could be with openings 20 or 22 and/or for one of the washers 12 or 16 may be made somewhat smaller so as to hold the washers 12 and 16 onto the fastener 40 adjacent the head 52 or extension 53 on the nut 48A.

Thus, with the fastener washer-lock washer combination of FIGS. 9 or 15, assembly is speeded as the washer-lock washer be it 10 (or one of the other versions), is already on the fastener, and the time to put the prior separate washer and lock washer in place is reduced. Further, should the combination be dropped, as it is still even bigger, it is easier to see and find, and also easier to see that if not put in place, is missing and needs to be put in place. Further, only one piece (the sanitary washer-lock washer), as opposed to two separate pieces, need be purchased, inventoried, handled, inspected, and assembled.

Thus, with the present invention the perceived quality of the assembled product is enhanced as the likelihood of a washer or lock washer being missing is greatly reduced, along with speeding assembly.

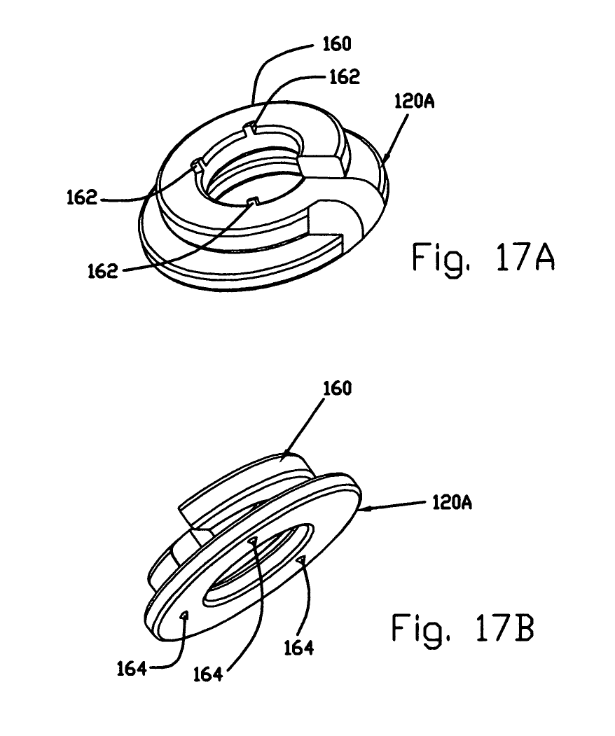

As shown in FIGS. 16A and 16B, the washer portion 120 could be non-round and this instance square. If the desired the corners 122 could be reduced instead of sharply cut as shown. The lock washer portion 160 has several protrusions 162 to help enhance its grip. These could be vertically oriented upward as shown with reference to FIG. 16A. As shown in 16B the washer portion 160 could have grip enhancing cones or dimples 164 formed therein. Of course such a washer-lock washer could be formed with or without either protrusions 160 or cones or dimples 164. The protrusions or cones or dimples could be formed in the punching or stamping operations. Now the protrusions 162 and/or cones or dimples 164 could be used in conjunction with a round washer portion 120A, as is shown in FIGS. 17A and 17B.

Further, the lock washer portion 160 could be separately formed and used alone; like a conventional lock washer, or could be joined as discussed herein to a washer portion to form a washer-lock washer combination, say as by welding or other techniques mentioned herein. This washer portion 160 would have the protrusions 162, which differentiate it from a conventional lock washer.

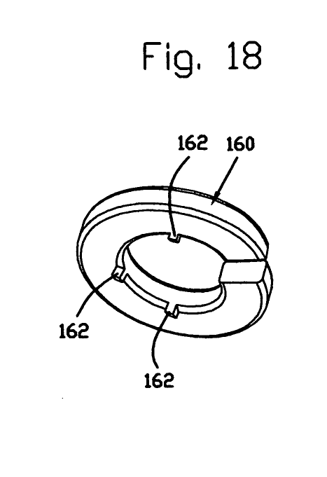

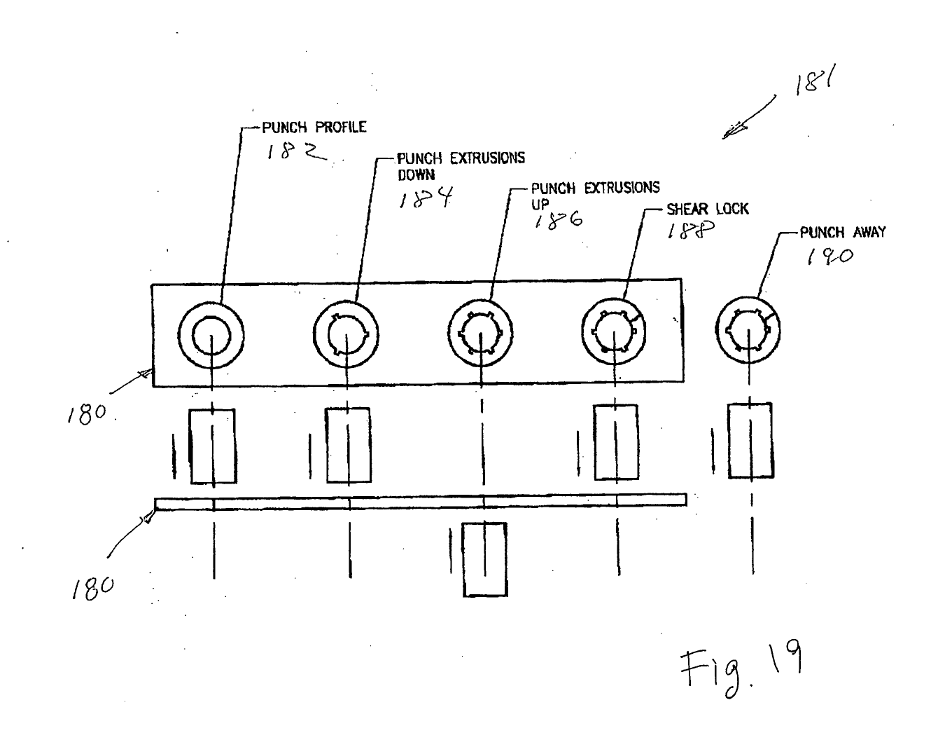

The single lock washers shown in FIGS. 18A and 18B could be made by the method and die 181 or tool shown in FIG. 19. Therein a strip 180 is progressively punched to form the inner and outer profiles (at 182) then punched to form the three or more downward extrusions or protrusions, say at a 120° apart, downwardly (at 184) then punched to form the upward extrusions or protrusions upwardly (at 186), then sheared to form the lock washer split (at 188) and finally punched away from the strip (at 190). Of course the lock washer could also be multiply ganged punched. The strip 180 would be moved along progressively in a die having the above described operations in this listed or other order. While three extensions or protrusions 162 are shown on each side, there could be more such as four or five on each side. Generally there would not be less than three per side. The protrusions could be provided just on one or the other side or as shown in FIG. 18, on both sides.

In a simplified form shown in FIG. 19 the die and method could be used to form the protrusions on the inside diameter or alternatively on the outer diameter or both of the single lock washer. The single lock washer protrusions, such as 162, provides increased locking features and actions to engage the fastener, nut, and/or work piece. The tooling stages are:

1. form the basic profile and pierce the hole (182);

2. form extrusions in one direction (184);

3. form extrusions in opposite direction (186);

4. shear lock (split) (188); and

5. punch completed profile away (cut-off)(190).

While the washer and lock washer portions can be joined by an integral tab, the washer and lock washer could be secured to each other, the fastener (bolt or nut) or one of the pieces or parts to be secured) together as by welding, say spot welding to minimize heat and distortion or by other means. Or, two separate pieces (washer and lock washer) may be joined by other methods or means as mentioned earlier.

While several embodiments of the apparatus and method of the present invention have been illustrated and described, it should be understood that such does not limit the scope of invention and that equivalent elements and steps will fall within the scope of the attached or subsequently to be attached claims in any successor application.

What is claim is:

1. A washer-lock washer, comprising a washer portion and a connected lock washer portion, both portions having generally axially aligned openings for receiving a fastener.

2. A method of making a washer-lock washer, comprising the steps of forming the profile of the washer-lock washer portions and the integral connection thereof of said portions, forming openings in the washer-lock washer portions, and keeping said washer-lock washer portions joined relative to one another, and generally axially aligning the openings in the washer-lock washer portions with one another.

3. A method as in claim 2, wherein said aligning comprises the step of relatively folding the portions over.

4. Washer-lock washer as in claim 1, further comprising a fastener, said washer-lock washer being retained on said fastener, whereby said fastener, washer-lock washer is ready for use.

5. A method of using a washer-lock washer, comprising the steps of placing a washer-lock washer on fastener, using the fastener with the washer-lock washer thereon to secure two parts together, using one of a threaded opening in one of said parts or a nut.

6. A method as in claim 5, further comprising the steps of, selecting a fastener of a desired size, thread and diameter, selecting a washer-lock washer each having an opening of diameters suitable for said fastener, assembling said selected washer-lock washer onto said fastener, retaining said washer-lock washer on said fastener, whereby said fastener, washer-lock washer is ready for use.

7. A method as in claim 6, wherein said washer portion engages relatively with said fastener to hold said washer-lock washer in place on said fastener ready for use.

8. A method as in claim 6, wherein at least one of the openings in said washer and lock-washer engaging said fastener and holding said washer-lock washer in place on said fastener, ready for use.

9. A die or tool for making a washer-lock washer, comprising a profile stage for providing the profile of said washer-lock washer, an opening stage for providing two openings in said washer-lock washer, and aligning stage for relatively aligning said two openings in said washer-lock washer to generally axially align.

10. A die or tool for making a washer-lock washer, as in claim 9, wherein said aligning stage comprises a folding stage for relatively folding over the washer-lock washer to generally align said two openings axially.

11. A method of producing a die or tool for forming or making a washer-lock washer, comprising the steps of creating a profile section, creating openings section for openings in said washer-lock washer, and creating a joining section for joining the washer and lock washer to generally axial align the openings therein.

12. A method as in claim 11, wherein said creating a joining section, comprises creating a folding stage for relatively folding over the washer-lock washer.

13. A lock washer having one of enhanced locking features, protrusions or nubs on at least one side to engage with one of a work piece, fastener and nut.

14. A die or tool for providing a lock washer as in claim 13, with one of several enhanced locking features, protrusions and nubs on at least one side to engage with one of a work piece, fastener and nut, said die having stages to provide profiles, openings, and one of said several enhanced locking features, protrusions, and nubs, and extending one of said several locking features, protrusions and nubs axially away from said washer.

15. A washer-lock washer as in claim 1, wherein said washer portion has a generally circular outer profile with a connecting tab on its circumference, said locking washer portion being of a conventional lock washer style with a connecting tab on its perimeter, said connecting tab on said washer portion being integral with said connecting tab on said lock washer portion.

16. A washer-lock washer as in claim 15, wherein said lock washer portion is a split lock washer, and said perimeter of said lock washer portion is generally circular.

17. A washer-lock washer as in claim 16, comprising one of steel, stainless steel, bronze, and plastic.

18. A washer-lock washer as in claim 17, wherein said lock washer portion is generally of a same or smaller diameter than a diameter of said washer portion, one or more of said washer portion and lock washer portion having protrusions on the surface away from the other portion and extending away therefrom to enhance the “grip” of the washer-lock washer.

19. A washer-lock washer as in claim 18, wherein the other of said washer-lock washer portions also has other protrusions on its other side, which extend away from the other of said washer-lock washer portion.
